(19) United States
(12) Patent Application Publication
(10) Pub. No.: US 2023/0204109 A1
(43) Pub. Date: Jun. 29, 2023

(54) VALVE FOR CONTROLLING FLUID FLOW AND USE THEREOF, AND VALVE INSERT FOR A VALVE HOUSING FOR CONTROLLING FLUID FLOW

(71) Applicant: Meibes System-Technik GmbH, Gerichshain (DE)

(72) Inventors: Jens KLEIN, Gerichshain (DE); Sebastian BLOCK, Gerichshain (DE); Ron SCHRAMEDEI, Gerichshain (DE)

(73) Assignee: Meibes System-Technik GmbH, Gerichshain (DE)

(21) Appl. No.: 18/145,369

(22) Filed: Dec. 22, 2022

(30) Foreign Application Priority Data
Dec. 23, 2021 (DE) 10 2021 134 501.4

(51) Int. Cl. F16K 3/26; F16K 3/314; F16K 39/02

(52) U.S. Cl. CPC F16K 3/267; F16K 3/314; F16K 39/022

(57) ABSTRACT

The invention relates to a valve for controlling a fluid flow, comprising at least one valve housing having at least one inlet and one outlet side, and a valve insert for regulating the fluid flow between the inlet side and the outlet side, which valve is arranged within the valve housing. The valve insert comprises at least one first element, designed as a hollow body, and a second element, wherein the second element is arranged within the first hollow-body-shaped element. Furthermore, the valve insert is arranged within the valve housing in such a way that the first element is axially fixed in the valve housing, and the second element is arranged so as to be rotationally fixed in the valve housing. The first element has at least one opening along the circumference of the first element for passing the fluid flow through and is designed to be rotatable relative to the second element; the second element is designed to be axially movable relative to the first element.

### CROSS-REFERENCE TO RELATED APPLICATIONS

This application claims priority to German Patent Application No. 10 2021 134 501.4 filed on Dec. 23, 2021, the entire contents of which are hereby incorporated by reference herein.

### FIELD OF THE INVENTION

The invention relates to a valve for controlling a fluid flow and to the use thereof, and to a valve insert for a valve housing for controlling a fluid flow.

### BACKGROUND OF THE INVENTION

Valves for controlling a fluid flow are used in many sectors, e.g., in heating and/or cooling systems, and usually have openings which are of variable design.

EP 3 163 135 A1 discloses a control valve with a valve body and a valve insert for controlling a fluid flow. In particular, the valve insert is designed in such a way as to compensate for manufacturing tolerances of the valve components, such as the valve cone. For this purpose, the valve insert has at least two portions which are movable relative to one another and, for example, enclose the valve cone in order to compensate for manufacturing tolerances.

EP 3 163 136 A1 shows a control valve that has at least two different valve characteristic curves and is thus better adapted for stroke limitation. For this purpose, the control valve has a closure arrangement with a closed state in which no fluid flows through the chamber, a first open state in which fluid flows through the chamber, and at least one second open state in which a smaller fluid flow flows through the chamber than in the first open state. Between the closed state and the second open state, the fluid flows through the valve according to a first valve characteristic curve and, between the second and the first open state, according to a second, different valve characteristic. A disadvantage of this valve is that the control accuracy of the valve decreases due to the stroke limitation.

EP 2 089 649 B1 discloses an adjustable regulator insert for a valve housing. The regulator insert has two inlet openings and an outlet opening which are sealed against each other. The size of the inlet opening can be changed by the overlap of a first recess on an outer cylinder and of a second recess on an inner cylinder of the regulator insert. To adjust the overlap, the inner cylinder is rotatable and axially displaceable.

EP 1 896 755 B1 discloses a control valve with a pre-adjustable flow. For this purpose, the control valve has an arrangement for regulating the flow, which comprises two interacting valve elements. The valve elements are designed as concentric rings and each have a recess. The inner valve element is rotatable and axially displaceable so as to vary the overlap of the recesses in the two valve elements.

EP 2 338 093 B1 discloses a control valve, in which a reduction of the flow opening by means of an actuator is achieved. For this purpose, the control valve comprises a flow control arrangement with outer and inner cylinder shell elements which have corresponding openings. A reduction in the flow opening is achieved by a rotation of the inner cylinder shell element and an axial mobility of the two cylinder shell elements.

WO 01 / 88418 A1 discloses a flow valve with adjustable presetting member and diaphragm for regulating and/or setting fluid quantities in systems with fluid-carrying media for limiting the medium to a preset maximum quantity, independently of a differential pressure acting across the valve, wherein the diaphragm opens or closes a number of openings in the wall by rolling onto a wall, characterized in that the openings are preferably smaller than half a part of that extension which is covered by the rolling of the diaphragm onto the wall. It is an object of the invention to provide a valve for controlling a fluid flow which has a constant, equal-percentage valve characteristic independent of a preset maximum value of the flow rate.

### SUMMARY OF THE INVENTION

It is an object of the invention to specify a valve for controlling a fluid flow, which valve has a constant, equal-percentage valve characteristic independent of a preset maximum value of the flow rate.

The object is achieved by a valve having the features of claim 1. The object is further achieved by a valve insert having the features of claim 7 and a method for operating a valve according to the features of claim 9. Preferred developments of the invention are the subject matter of dependent claims.

### BRIEF DESCRIPTION OF THE DRAWINGS

The invention will be explained in greater detail below with reference to some embodiments and accompanying drawings. The embodiments are intended to describe the invention without limiting it.

Shown are:

FIG. 1 an embodiment of a valve according to the invention,

FIG. 2 an embodiment of a valve insert according to the invention, and

FIG. 3 a further embodiment of a valve insert according to the invention,

FIG. 4 schematically, the area A_{eff} that can be flowed through formed by the flow-conducting structures on a height line.

### DETAILED DESCRIPTION OF THE INVENTION

According to the invention, a valve for controlling a fluid flow comprises at least one valve housing with at least one inlet and one outlet side, and a valve insert for regulating the fluid flow between the inlet side and the outlet side, which valve insert is arranged within the valve housing. According to the invention, the valve insert comprises at least one first element, designed as a hollow body, and a second element, wherein the second element is arranged within the first hollow-body-shaped element. Furthermore, the valve insert is arranged within the valve housing in such a way that, in the valve housing, the first element is axially fixed, and the second element is arranged so as to be rotationally fixed. According to the invention, the first element has at least one opening along the circumference of the first element for passing the fluid flow through and is designed to be rotatable relative to the second element. Furthermore, the second element is designed to be axially movable relative to the first element.

Advantageously, such a valve has a constant, equal-percentage valve characteristic independent of a preset maximum value of the flow rate. Further advantageously, a continuous control of the volume flow of a fluid over a control range of the valve is made possible. The control range within the meaning of the invention means a region within which the continuous adjustment of the flow rate of a fluid flow through the valve between zero and a preset maximum value of the flow rate is possible. The preset maximum value of the flow rate is less than or equal to the maximum possible flow rate through the valve without a preset maximum value, and corresponds to 100%. The control range corresponds to the valve stroke of the valve, and thus a preset maximum value of the flow rate limits the valve stroke of the valve. In embodiments, the ratio between the maximum flow rate and the minimum flow rate of the valve is five.

Furthermore, the presetting of a maximum value of the flow rate is, advantageously, made possible by the first element being designed to be rotatable relative to the second element. The second element, which is axially movable relative to the first element and is rotationally fixed relative to the valve housing, advantageously enables the continuous adjustment of the flow between zero and the preset maximum value. Such a valve has a better control accuracy, as a result of which a higher thermal comfort is ensured when the valve according to the invention is used in heating and/or cooling systems. Particularly in the partial load range, such a valve has a significantly improved control accuracy due to a constant, equal-percentage valve characteristic curve or valve characteristic. Partial load range means an operating range of the valve at a preset maximum value of the flow rate that is smaller than an operating range of the valve without a preset maximum value of the flow rate.

A fluid flow within the meaning of the invention means a flow of a fluid, such as liquids according to DIN EN 12828. In embodiments, the fluid is selected from gases, heating water according to VDI 2035, and water-glycol mixtures with a maximum glycol fraction of 50%.

An element designed as a hollow body in the sense of the invention means an axially-extended hollow body with a cross-section of any shape, wherein the cross-sectional shape of the hollow body is designed such that the second element is arranged within the hollow body. The cross-section of the hollow body means a surface perpendicular to the axial extent of the hollow body. In embodiments, the cross-section has an elliptical, circular, or polygonal shape. In further embodiments, the dimensions of the cross-section can vary along the axial extent of the hollow body. In the case of a hollow cylinder, the inner or outer diameter of the hollow cylinder can thus vary along its axial extent. An axially-extended hollow body has at least one inner surface and an outer surface which are spaced apart from one another by a wall thickness of the hollow body. In this case, the inner surface of the hollow body delimits the volume enclosed by the hollow body and faces the second element. The outer surface of the hollow body faces the valve housing. In embodiments, the wall thickness of the hollow body varies along the axial extent of the hollow body.

The axially-extended hollow body furthermore has at least one end face which is oriented at an angle to the axial extent of the hollow body, and preferably oriented to be perpendicular to the axial extent. A hollow body of this kind is open on one side. In embodiments, the at least one end face of the axially-extended hollow body has a recess for passing a spindle through. The spindle can advantageously be connected to an actuating drive in order to achieve the axial mobility of the second element relative to the first element. In embodiments, the spindle forms the axis of the valve along which the axially-extended first and second elements are aligned.

In embodiments, the second element is designed as an axially-extended hollow or solid body with a cross-section of any shape, and preferably as an axially-extended hollow body. An axially-extended solid body with a cross-section of any shape can, for example, be a solid cylinder. In further embodiments, the dimensions of the cross-section of the hollow or solid body can vary along the axial extent of the hollow or solid body. The wall thickness of a first element formed as an axially-extended hollow body can also vary along the axial extent.

In further embodiments, the first and the second elements are made of plastic — preferably of a reinforced plastic — for example, glass-fiber-reinforced plastic.

In the sense of the invention, axially fixed means that the first element designed as a hollow body is fixed in its axial arrangement within the valve housing. The axial arrangement of the first element within the valve housing is therefore not variable.

Within the meaning of the invention, rotationally fixed means that the second element is arranged within the valve housing such that a rotation of the second element relative to the valve housing is not possible.

In the sense of the invention, rotatable means that a rotation of the first element relative to the second element is possible. This allows the presetting of a maximum value of the flow rate. In embodiments, the first element is designed to be rotatable relative to the second element in a manual way - for example, by means of a jaw wrench. This advantageously allows presetting a maximum value of the flow by the user of the valve. Further advantageously, the presetting of a maximum value without disassembly of the valve is possible.

Axially movable within the meaning of the invention means that the axial arrangement of the second element arranged within the first element is variable relative to the first element. This enables the continuous adjustment of the flow between zero and the preset maximum value. In embodiments, the second element is axially movable relative to the first element by means of an actuating drive. Advantageously, the automated, continuous adjustment of the flow rate through the valve between zero and a preset maximum value of the flow rate is thereby made possible. Furthermore, advantageously, such a valve represents an automatic quantity limiter with a two-way control valve. This advantageously ensures a high valve authority and at the same time prevents an oversupply in the heating or cooling system at any time. The actuating drive can be an actuating drive known to the person skilled in the art - for example, a thermoelectric or an electric motor actuator. In embodiments, the second element is axially movable, relative to the first element, without an actuating drive. Such a valve is, advantageously, an automatic quantity limiter and guarantees the provided flow in the terminals, irrespective of requirements of other consumers or strands in the system, and thus saves energy.

According to the invention, the first element has at least one opening for the passage of the fluid flow. In embodiments, the at least one opening can have any shape - for example, an elliptical, round, or polygonal shape. In further embodiments, the at least one opening has a polygonal, and preferably rectangular, shape. In the case of a polygonal shape of the at least one opening, it can be advantageous if the corners are rounded. In further embodiments, the first element designed as a hollow body has four openings, wherein the openings are each formed in the same way and are arranged along a height line of the first element. A height line here means a line running around the circumference of the first element at a height of the axial extent of the first element.

In embodiments, the valve insert comprises a first element, formed as a hollow cylinder, and a second element. In embodiments, the inner and/or outer diameter of the hollow cylinder can vary along the axial extent of the hollow cylinder.

In embodiments, the valve housing further comprises at least one measurement connector, and preferably at least two measurement connectors. Advantageously, a rapid functional test, e.g., the check of the flow rate, is thereby made possible.

In preferred embodiments, the valve further comprises a differential pressure compensation unit. Advantageously, pressure fluctuations are thereby compensated for in order to keep the flow of the fluid flow constant.

In embodiments, the differential pressure compensation unit has at least one component, designed as an axially-extended hollow cylinder, a first and a second cup-shaped component, a spring, and a membrane. Advantageously, when the flow is flowing on the underside of the membrane of the valve, a pre-pressure p₁ is present, and, on the upper side of the membrane after flowing through the first and second element, a static pressure p₂ is present. As a function of the pre-pressure p₁, an adjustment of the distance between the axially-extended hollow cylinder and the second cup-shaped component takes place, so that a difference p₁-p₂ remains constant.

In further embodiments, the differential pressure compensation unit can also be designed according to differential pressure compensation units known to the person skilled in the art, as known, for example, from EP 2 338 093 B1 or EP 1 896 755 B1.

In preferred embodiments, the first element has flow-conducting structures on a first portion of its inner surface, or the second element has such structures on a first portion of its surface. An axial passage of the fluid flow through the valve is, advantageously, achieved by the flow-conducting structures. In this case, the fluid flow is, advantageously, conducted only through the first element, and not through the second element. Furthermore, such a valve advantageously has an equal-percentage-modified valve characteristic (also known as EQM characteristic). As a result, when the overall system is viewed from the superposition of a typical characteristic curve of a heat exchanger (usually shown as heat dissipation in % as a function of the flow rate in %) and of the valve according to the invention (usually shown as flow in % as a function of the valve stroke in %), a linear characteristic curve of the controlled system is obtained, i.e., between the manipulated variable, such as the control voltage of an actuator, and the target variable, such as the amount of heat delivered in % as a function of the flow in %, there is a simple, linear relationship, wherein approximately the same control accuracy prevails throughout the operating range.

Flow-conducting structures within the meaning of the invention may be structures, arranged on and/or in the inner surface of the first element or the surface of the second element, which are suitable for conducting the fluid flow. Such suitable structures are recesses and/or elevations introduced in embodiments on the inner surface of the first element or the surface of the second element - for example, in the form of indentations. In this case, the introduced depressions define a flow path between the inner surface of the first element and the surface of the second element along which the axial flow through the valve takes place. In embodiments, the flow path formed by the recesses of the flow-conducting structures has a cross-sectional area, the area A_{eff} that can be flowed through along a height line, wherein the flow is dependent upon the area A_{eff} that can be flowed through. In further embodiments, the flow-conducting structures are designed such that the valve has an EQM function according to formula I

$$\dot{v} \left(h\right) = \frac{{a}_{p o w e r}}{\frac{1}{h} - 1 + {a}_{p o w e r}}$$

where v(h) is the relative volumetric flow rate (or also relative flow rate) as a function of relative stroke h of the valve, a_{power} is a parameter depending upon stroke h, and stroke h. a_{power} is calculated according to formula II

$${a}_{p o w e r} = {a}_{1} + \left({a}_{2} - {a}_{1}\right) \times {a}_{f a c t o r}$$

with parameters a_{1,} a₂, and a₃ and weighting factor a_{factor}, wherein a_{factor} can be represented by formula III.

$${a}_{f a c t o r} = {h}^{{a}_{3}}$$

In embodiments, the parameters a_{1,} a₂, and a₃ are freely selectable and are preferably a₁ = 0.1, a₂ = 0.5, and a₃ = 1.4.

In further embodiments, the flow-conducting structures are designed such that the area that can be flowed through A_{eff} increases with increasing relative stroke h of the valve along an axial direction of the valve. An increase in the area that can be flowed through A_{eff} thereby takes place by increasing a circumferential length u of the recesses along the circumference of the first or second element and a radial opening gap Δr. The area that can be flowed through A_{eff} is a function of the stroke h of the valve, the circumferential length u, and opening gap Δr. In further embodiments, the area that can be flowed through is formed at least in one part. In embodiments, the area that can be flowed through is formed in several parts. This advantageously achieves virtually the same inflow conditions at each set maximum value of the flow rate.

The circumferential length u of the recesses means the extent of the recesses along the circumference of the first or second element on a height line.

A radial opening gap Δr means in this case a gap ensuring the flow through of the fluid along a radial direction of the valve between the first and the second element, which is delimited by the inner surface of the first element and the surface of the second element along a height line. The radial direction of the valve is oriented to be perpendicular to the valve axis.

The surface of the second element means the surface of the second element which faces the first element in the valve. If the second element is designed as a hollow body, the surface of the second element is the outer surface of the second element which faces the first element in the valve.

In embodiments, the first element formed as a hollow body has a first, a second, and a third region in successive arrangement. In embodiments, the third region of the first element has the first portion of the inner surface with the flow-conducting structures. In further embodiments, the first region of a first element formed as an axially-extended hollow cylinder has a smaller inner and outer diameter than the second and third region of the first element designed as a hollow cylinder.

In further embodiments, the second element has a first and a second sub-region in successive sequence. In embodiments, the second sub-region of the second element has the first portion of the surface with the flow-conducting structures. In further embodiments, the first sub-region of a second element designed as an axially-extended hollow or solid cylinder has a smaller inner and outer diameter or outer diameter than the second sub-region of the second element. Advantageously, the diameters of the first and second elements are matched to one another, so that the arrangement of the second element within the first element is ensured.

The first portion of the inner surface of the first element and the first portion of the surface of the second element each mean portions of the first and second elements that are in contact with the fluid flow during operation of the valve.

In further embodiments, the first element, on a second portion of its inner surface, and the second element, on a second portion of its surface, have respective stroke-limiting structures. A stroke-limiting structure within the meaning of the invention means any structure that is suitable for limiting the valve stroke, i.e., the axial mobility of the second element relative to the first element. Such suitable structures are designed, for example, as oblique planes on the first and second elements, which convert a rotation of the first element relative to the second element into a translational movement. In further embodiments, the stroke-limiting structures of the first and of the second elements engage in one another and correspond to one another. Advantageously, such stroke-limiting structures interact with one another in a thread-like manner in order to limit the axial mobility of the second element relative to the first element. In further embodiments, the stroke-limiting structures of the first and second elements are formed as thread turns, and preferably as two thread turns. In further embodiments, the stroke is limited by the stroke-limiting structures to a range of 2 mm to 4 mm, and preferably 2.7 mm.

In embodiments, the second region of the first element has the second portion of the inner surface of the first element with the stroke-limiting structures. In further embodiments, the second sub-region of the second element has the second portion of the surface with the stroke-limiting structures. The second portion of the inner surface of the first element and the second portion of the surface of the second element each indicate portions of the first and second elements that are in contact with the fluid during operation of the valve.

In further embodiments, the valve stroke can be limited by means of an actuating drive. This can take place by the actuating drive permanently receiving an actuating signal, such as an electrical voltage, that is between the actuating signal for the completely open state of the valve and the actuating signal for the completely closed state of the valve. This advantageously achieves a limitation of the operating range of the actuating drive, and thus stroke limitation.

In preferred embodiments, the at least one opening extends along nearly 360° of the circumference of the first element. Advantageously, the flow of the fluid flow through the first element is thereby achieved.

In further embodiments, the at least one opening extends along 300° to 340° of the circumference of the first element.

In further embodiments, the at least one opening extends over its full circumference along the circumference of the first element. Full circumference means that the at least one opening extends along 85% to 95% of the circumference of the first element.

In preferred embodiments, the first element and/or the second element are formed at least in one piece.

In further embodiments, the first and/or the second elements are designed in several parts. This can be advantageous in terms of manufacturing-relevant aspects. In embodiments, the first element is formed in two parts. In this case, the first element advantageously comprises a first part which comprises the first and second regions of the first element, and a second part which comprises the third region of the first element. The first and the second parts of the first element can, in embodiments, be connected to one another by means of joining methods.

In preferred embodiments, the first and the second elements have several circumferential grooves for receiving sealing means. Advantageously, this ensures the sealing between the first and the second element and the valve housing.

In embodiments, the first element has four circumferential grooves for receiving sealing means. Advantageously, the seal between the first element and the valve housing is thereby achieved.

In further embodiments, the second element has two circumferential grooves for receiving sealing means. Advantageously, the seal between the second and the first element is thereby achieved.

A further aspect of the invention relates to a valve insert for a valve housing having at least one inlet and one outlet side for regulating a fluid flow between the inlet side and the outlet side, comprising at least one first element, designed as a hollow body, and a second element, wherein the second element is arranged within the first element, and the valve insert is designed to be arranged in the valve housing such that the first element is axially fixed in the valve housing, and the second element is arranged in the valve housing so as to be rotationally fixed, and wherein the first element has at least one opening along the circumference of the first element for passing the fluid flow through and wherein the first element is designed to be rotatable relative to the second element, and wherein the second element is designed to be movable axially relative to the first element.

Such a valve insert advantageously allows the presetting of a maximum value of the flow rate and the continuous control of the flow between zero and the preset maximum value. Furthermore, a valve insert according to the invention can be used in valve housings and thus offers flexibility, in terms of production, in the functionalization of valve housings.

In embodiments, the valve insert comprises a first element, formed as a hollow cylinder, and a second element. In embodiments, the inner and/or outer diameter of the hollow cylinder can vary along the axial extent of the hollow cylinder.

In preferred embodiments of the valve insert, the first element, on its inner surface, or the second element, on its surface, has flow-conducting structures.

The invention also relates to a method for operating a valve with a constant, equal-percentage valve characteristic, independently of a preset maximum value of the flow rate, comprising a valve housing with at least one inlet and one outlet side, and a valve insert for regulating the fluid flow between the inlet side and the outlet side, which valve insert is arranged within the valve housing. According to the invention, the valve insert comprises at least one first element, designed as a hollow body, and a second element, wherein the second element is arranged within the first element. Furthermore, according to the invention, the valve insert is arranged within the valve housing in such a way that the first element is axially fixed in the valve housing, and the second element is arranged in the valve housing so as to be rotationally fixed. According to the invention, the first element has at least one opening along the circumference of the first element for passing the fluid flow through and is designed to be rotatable relative to the second element. Furthermore, according to the invention, the second element is designed to be axially movable relative to the first element. According to the invention, the method includes the steps of adjusting the rotation of the first element relative to the second element in order to achieve a presetting of a maximum value of the flow rate of the fluid flow, and axially moving the second element relative to the first element in order to continuously control the flow rate between zero and the preset maximum value.

This advantageously achieves a presetting of a maximum value of the flow rate and the continuous control between zero and the preset maximum value of the flow rate. Furthermore, improved control accuracy and thus higher thermal comfort is, advantageously, achieved. Particularly in the partial load range, a significantly improved control accuracy and a constant valve characteristic curve or valve characteristic are achieved.

A further aspect of the invention is the use of a valve according to the invention as a zone valve or individual space control valve in heating and/or cooling systems, and/or for carrying out a method according to the invention.

An automatic hydraulic compensation is thereby, advantageously, made possible. For this purpose, the valve according to the invention is set to the required flow rate and compensates for pressure fluctuations in the heating and/or cooling system. Furthermore, the pump capacity within the heating and/or cooling system is, advantageously, reduced to a minimum in order to avoid unnecessary energy consumption. Furthermore, the presetting of a maximum value of the flow rate and the continuous control of the flow between zero and the preset maximum value is also, advantageously, made possible.

A zone valve in the sense of the invention means a valve - for example, for regulating the heating or cooling power in conference rooms or large-scale offices. An individual space regulating valve in the sense of the invention means a valve for regulating the heating or cooling power in a single space.

In embodiments, a valve according to the invention is used for supplying floors or lines in apartment construction.

A further aspect of the invention is the use of a valve insert according to the invention in a valve housing and/or for carrying out a method according to the invention.

In order to implement the invention, it is also expedient to combine the above-described embodiments and features of the claims. The invention is not limited to the illustrated and described embodiments, but also includes all embodiments which act identically within the meaning of the invention. Furthermore, the invention is also not limited to the specifically described feature combinations, but may also be defined by any other combination of particular features of all individual features disclosed overall, provided the individual features are not mutually exclusive, or a specific combination of individual features is not explicitly excluded.

### Exemplary Embodiments

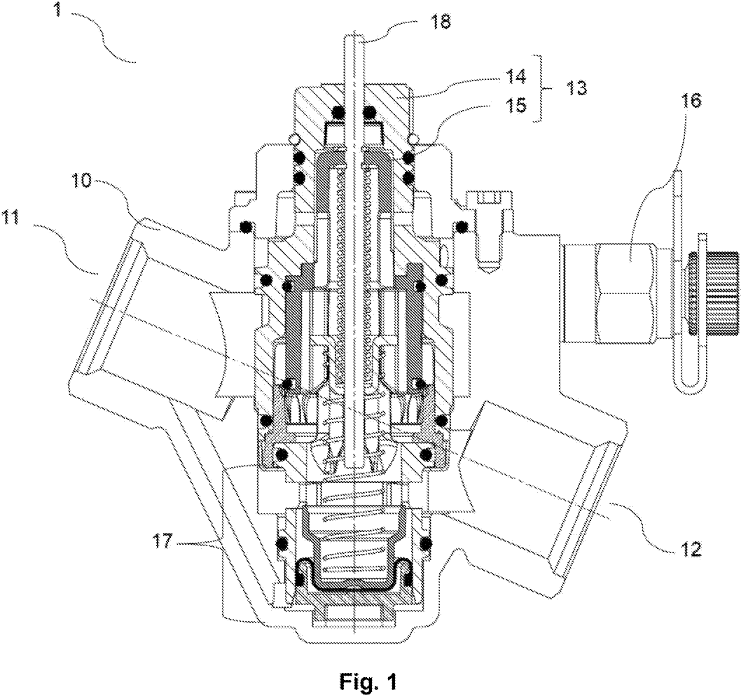

FIG. 1 shows an embodiment of a valve 1 according to the invention. The valve 1 comprises at least one valve housing 10 having an inlet and an outlet side 11, 12 and a valve insert 13. The valve insert 13 comprises at least a first element 14, designed as a hollow body, and a second element 15, wherein the second element 15 is arranged within the first element 14. The valve 1 further comprises at least one measurement connector 16 and a differential pressure compensation unit 17. The spindle 18 to which an actuator is connected in embodiments in order to axially move the second element 15 relative to the first element 14 can also be seen. The valve insert 13 is arranged within the valve housing 10 such that the first element 14 is axially fixed in the valve housing, and the second element 15 is rotationally fixed. The first element 14 is rotatable relative to the second element 15.

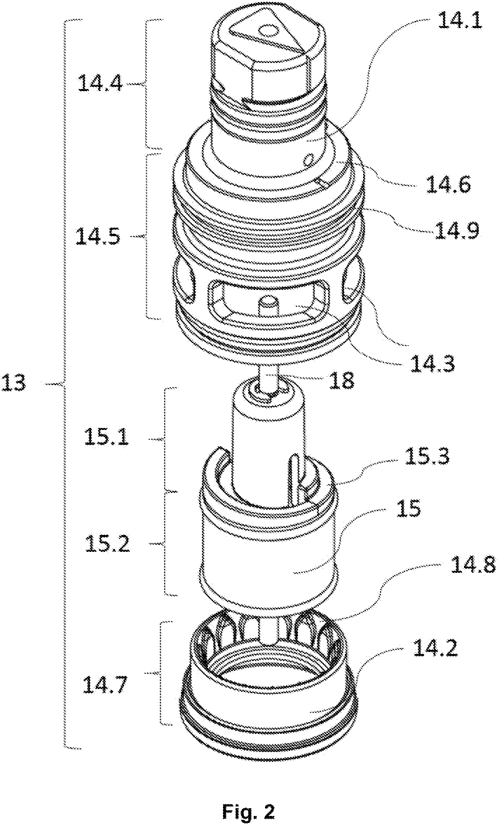

FIG. 2 shows an embodiment of a valve insert 13 according to the invention. The valve insert 13 comprises a multi-part first element 14 designed as a hollow cylinder, which comprises a first part 14.1 and a second part 14.2 which can be connected to one another by means of joining methods, and a second element 15. The second element 15 is arranged within the first element 14. In one embodiment, the first element 14 has four uniform openings 14.3 for passing a fluid flow through which extend along almost 360° of the circumference of the first element 14. The inner and outer diameters of the first element 14 designed as a hollow cylinder vary along the axial extent of the first element 14. The first part 14.1 has the first 14.4 and second region 14.5 of the first element 14, wherein the second region 14.5 has the second portion with the stroke-limiting structures 14.6. FIG. 2 shows that the first region 14.4 of the first element 14 has smaller diameters than the second 14.5 and third region 14.7. The second part 14.2 has the third region 14.7 of the first element 14, wherein the third region 14.7 has the first portion with the flow-conducting structures 14.8. FIG. 2 shows by way of example one of the several circumferential grooves 14.9 for receiving sealing means. The second element 15 is designed as a hollow cylinder, wherein the inner and outer diameters of the hollow cylinder vary along the axial extent of the second element 15. The second element 15 has, on an end face, a recess for passing a spindle 18 through. The spindle 18 can be connected to an actuator (not shown). The second element 15 has a first 15.1 and a second 15.2 sub-region, wherein the diameter of the first sub-region 15.1 is smaller than the diameter of the second sub-region 15.2. Furthermore, the stroke-limiting structures 15.3 in the second sub-region 15.2 are on a second portion of the surface of the second element 15. The stroke-limiting structures 14.6, 15.3 are designed such that they interact with one another in a thread-like manner in order to limit the axial mobility of the second element 15 relative to the first element 14.

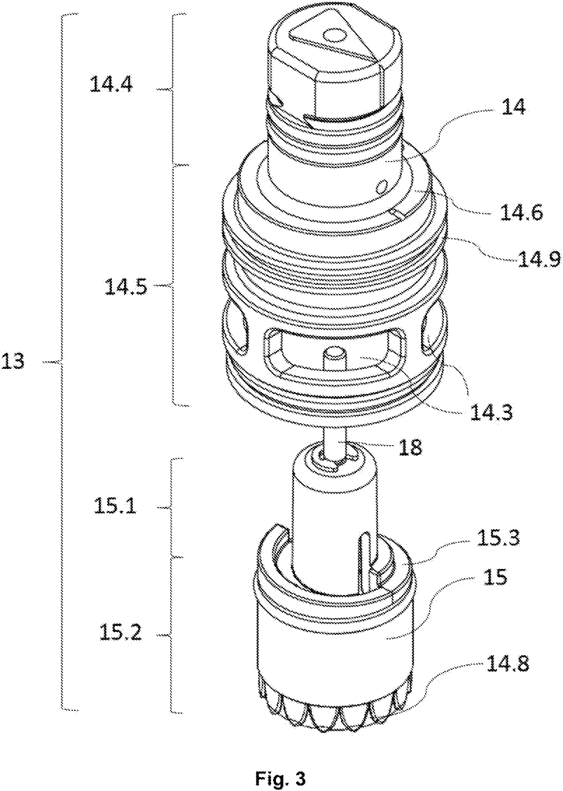

FIG. 3 shows a further embodiment of a valve insert 13 according to the invention. The valve insert 13 comprises a single-part element 14, designed as a hollow cylinder, and a second element 15. The first element 14 has a first 14.4, a second 14.5, and a third region 14.7. FIG. 3 shows that the first region 14.4 of the first element 14 has smaller diameters than the second 14.5 and third region 14.7. The second element 15 is arranged within the first element 14. In one embodiment, the first element 14 has four uniform openings 14.3 for passage of a fluid flow which extend along nearly 360° of the circumference of the first element. The inner and outer diameters of the first element 14 designed as a hollow cylinder vary along the axial extent of the first element 14. The first element 14 has a second portion of its inner surface with stroke-limiting structures 14.6. FIG. 3 shows by way of example one of the several circumferential grooves 14.9 for receiving sealing means. The second element 15 is designed as a hollow cylinder, wherein the inner and outer diameters of the hollow cylinder vary along the axial extent of the second element 15. The second element 15 has a first 15.1 and a second 15.2 sub-region, wherein the diameter of the first sub-region 15.1 is smaller than the diameter of the second sub-region 15.2. The second sub-region 15.2 comprises a second portion of the surface of the second element 15 with stroke-limiting structures 15.3. The stroke-limiting structures 14.6, 15.3 are designed such that they interact with one another in a thread-like manner in order to limit the axial mobility of the second element 15 relative to the first element 14. The second element 15 has, on an end face, a recess for passing a spindle 18 through. The spindle 18 can be connected to an actuator (not shown). Likewise, FIG. 3 shows the flow-conducting structures 15.4 on a first portion of the surface of the second element, wherein the first portion is comprised by the second sub-region 15.2.

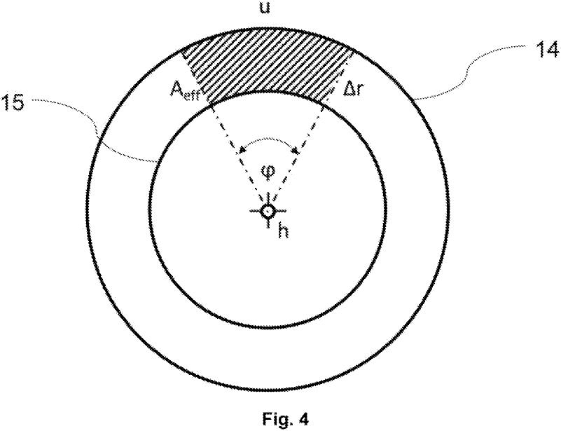

FIG. 4 schematically shows a plan view along an axial direction on the first 14 and the second elements 15, and the thus formed area A_{eff} that can be flowed through on a height line. In this case, Δr denotes a radial opening gap, and u denotes a circumferential length. The radial opening gap forms along a radial direction of the valve between the first 14 and the second elements 15 and is limited by the inner surface of the first element 14 and the surface of the second element 15 along a height line. The radial direction is oriented to be perpendicular to the axial direction or to the valve axis. The circumferential length u of the recesses of the flow-conducting structures is the extent of the recesses along the circumference of the first 14 or second element 15 on a height line.

Reference signs

| | |
|---|---|
| 1 | Valve |
| 10 | Valve housing |
| 11 | Inlet side |
| 12 | Outlet side |
| 13 | Valve insert |
| 14 | First element |
| 14.1 | First part of the first element |
| 14.2 | Second part of the first element |
| 14.3 | At least one opening |
| 14.4 | First region of the first element |
| 14.5 | Second region of the first element |
| 14.6 | Stroke-limiting structures on the inner surface of the first element |
| 14.7 | Third region of the first element |
| 14.8 | Flow-conducting structures |
| 14.9 | Circumferential groove |
| 15 | Second element |
| 15.1 | First sub-region of the second element |
| 15.2 | Second sub-region of the second element |
| 15.3 | Stroke-limiting structure on the surface of the second element |
| 16 | Measurement connector |
| 17 | Differential pressure compensation unit |
| 18 | Spindle |

1. A valve (1) for controlling a fluid flow, comprising at least:
a valve housing (10) having at least one inlet (11) and one outlet side (12), and a valve insert (13) for regulating the flow of fluid between the inlet (11) and the outlet side (12), which insert is arranged within the valve housing (10), wherein the valve insert (13) comprises at least a first element (14), formed as a hollow body, and a second element (15), and wherein the second element (15) is arranged within the first hollow body element (14), and wherein the valve insert (13) is arranged within the valve housing (10) such that the first element (14) is axially fixed in the valve housing (10), and the second element (15) is arranged in the valve housing (10) so as to be rotationally fixed, and wherein the first element (14) has at least one opening (14.3) along the circumference of the first element (14) for passing the fluid flow through and is rotatable relative to the second element (15), and wherein the second element (15) is formed so as to be axially movable relative to the first element (14).

2. The valve (1) according to claim 1, wherein the valve (1) further comprises a differential pressure compensation unit (17).

3. The valve (1) according to claim 1, wherein the first element (14), on a first portion of its inner surface, or the second element (15), on a first portion of its surface, has flow-conducting structures (14.8).

4. The valve (1) according to claim 1, wherein the at least one opening (14.3) extends along nearly 360° of the circumference of the first element (14).

5. The valve (1) according to claim 1, wherein the first element (14) and/or the second element (15) is formed at least in one piece.

6. The valve (1) according to claim 1, wherein the first element (14) and the second element (15) have several circumferential grooves (14.9) for receiving sealing means.

7. A valve insert (13) for a valve housing (10) having at least one inlet (11) and one outlet side (12) for regulating a flow of fluid between the inlet (11) and the outlet side (12), comprising at least
a first element (14), designed as a hollow body, and
a second element (15),
wherein the second element (15) is arranged within the first element (14), and the valve insert (13) is designed to be arranged in the valve housing (10) such that the first element (14) is axially fixed in the valve housing (10), and the second element (15) is arranged so as to be rotationally fixed in the valve housing (10), and wherein the first element (14) has at least one opening (14.3) along the circumference of the first element (14) for passing the fluid flow through and is designed to be rotatable relative to the second element (15), and wherein the second element (15) is designed to be axially movable relative to the first element (14).

8. The valve insert (13) according to claim 7, wherein the first element (14), on its inner surface, or the second element (15), on its surface, has flow-conducting structures (14.8).

9. A method for operating a valve (1) having a constant, equalpercentage valve characteristic independent of a preset maximum value of the flow rate, comprising a valve housing (10) having at least one inlet (11) and one outlet side (12), and a valve insert (13) for regulating a fluid flow between the inlet (11) and the outlet side (12), which valve insert is arranged within the valve housing (10), wherein the valve insert (13) comprises at least a first element (14), designed as a hollow body, and a second element (15), and wherein the second element (15) is arranged within the first element (14), and wherein the valve insert (13) is arranged within the valve housing (10) such that the first element (14) is axially fixed in the valve housing (10), and the second element (15) is arranged so as to be rotationally fixed in the valve housing (10),
and wherein the first element (14) has at least one opening (14.3) along the circumference of the first element (14) for passing the fluid flow through and is designed to be rotatable relative to the second element (15), and wherein the second element (15) is designed to be axially movable relative to the first element (14),
comprising the steps of
adjusting the rotation of the first element (14) relative to the second element (15) to achieve a preset of a maximum value of the flow rate of the fluid flow,
axially moving the second element (15) relative to the first element (14) to continuously control the flow rate between zero and the preset maximum value.

10. The valve (1) according to claim 1, wherein the valve is a zone valve or an individual space control valve in a heating and/or cooling system.

11. A valve housing comprising the valve insert (13) according to claim 7.

12. The valve (1) according to claim 2, wherein the first element (14), on a first portion of its inner surface, or the second element (15), on a first portion of its surface, has flow-conducting structures (14.8).

13. The valve (1) according to claim 2, wherein the at least one opening (14.3) extends along nearly 360° of the circumference of the first element (14).

14. The valve (1) according to claim 3, wherein the at least one opening (14.3) extends along nearly 360° of the circumference of the first element (14).

15. The valve (1) according to claim 12, wherein the at least one opening (14.3) extends along nearly 360° of the circumference of the first element (14).

16. The valve (1) according to claim 2, wherein the first element (14) and/or the second element (15) is formed at least in one piece.

17. The valve (1) according to claim 15, wherein the first element (14) and/or the second element (15) is formed at least in one piece.

18. The valve (1) according to claim 2, wherein the first element (14) and the second element (15) have several circumferential grooves (14.9) for receiving sealing means.

19. The valve (1) according to claim 12, wherein the first element (14) and the second element (15) have several circumferential grooves (14.9) for receiving sealing means.

20. The valve (1) according to claim 17, wherein the first element (14) and the second element (15) have several circumferential grooves (14.9) for receiving sealing means.
